(19) United States
(12) Patent Application Publication
(10) Pub. No.: US 2014/0334394 A1
(43) Pub. Date: Nov. 13, 2014

(54) Method and Base Station for Power Allocation in Wireless System

(71) Applicant: Honglai Liu, Beijing (CN)

(72) Inventor: Honglai Liu, Beijing (CN)

(73) Assignee: TELEFONAKTIEBOLAGET L M ERICSSON (PUBL), Stockholm (SE)

(21) Appl. No.: 14/110,609

(22) PCT Filed: Apr. 13, 2011
(86) PCT No.: PCT/CN2011/000647

§ 371 Date: Oct. 29, 2013

(51) Int. Cl. H04W 52/34; H04L 5/00; H04W 52/26; H04W 72/04

(52) U.S. Cl. CPC H04W 52/346; H04W 72/0413; H04L 5/0037; H04W 52/262
USPC 370/329

(57) ABSTRACT

A base station in a LTE system and a method for use in the base station (400) are provided for allocating power in downlink transmissions for a UE. A report is received, from the UE, comprising a Reference Signal Received Quality, RSRQ, indicating a current channel quality of a downlink transmission with multiple subcarriers. A fairness factor used for achieving fairness in scheduling between UEs served by the base station is retrieved, from a resource management scheduler of the base station; and a combined factor is determined based on the received RSRQ and the retrieved fairness factor, for resource blocks, RBs, related to the downlink transmissions, the RBs comprising subcarriers pertaining to resources to be allocated to the UE. Then, a power is determined for the resource RBs based on the determined combined factor; and the determined power for the downlink transmission for the UE is allocated.

### TECHNICAL FIELD

Embodiments herein relate generally to adaptive power allocation to user equipments in an Long Term Evolution (LTE) system and in particular to adaptive power allocation considering both channel quality and fairness when allocation power to user equipments.

### BACKGROUND

Third generation partnership project (3GPP) dealing with LTE is the latest standard in the mobile network technology. An object of LTE is to offer increased capacity and data rates for the users for mobile broadband. LTE meets the requirements of downlink data rates of at least 100 Mbit/s and uplink data rates of 50 Mbit/s. LTE also meets the requirement of a maximum round trip time of 30 MS.

Contrary to former mobile communication systems, LTE supports Frequency Division Duplex (FDD) and Time Division Duplex, (TDD). As a consequence, radio resources for LTE can be represented by a two dimensional grid, see FIG. 1, illustrating normal Cyclic Prefix (CP) condition. In the grid of FIG. 1, a Resource Element 100 (RE) comprises one subcarrier as indicated on the frequency axis and a minimum time unit as indicated on the time axis. During the minimum time unit, twelve subcarriers constitute one Orthogonal Frequency Division Multiplexing (OFDM) symbol. For normal CP seven consecutive OFDM symbols, i.e. 0.5 ms, constitute a Resource Block forming one time slot. For extended CP, six consecutive OFDM symbols, i.e. 0-0.5 ms, constitute a Resource Block, forming one time slot. The minimum scheduling unit consists of two resource Blocks (RBs) within one subframe of 1 ms, i.e. 14 consecutive OFDM symbols for normal CP, and 12 consecutive OFDM symbols for extended CP.

An RE has a specific energy, normally referred to as Energy Per Resource Element (EPRE) also usually denoted E_{A} and E_{B}. Some of the REs comprise reference signals, which also have an EPRE, denoted E_{RS}.

Downlink power allocation is disclosed in Technical Specification (TS) 3GPP TS 36.213 entitled: “Group Radio Access Network; Evolved Universal Terrestrial Radio Access (E-UTRA); Physical layer procedures” in which disclosed two parameters, which define a ratio

$$\frac{{ρ}_{A}}{{ρ}_{B}}$$

among different types of REs to satisfy system requirements, wherein ρ_{A} is the ratio of the Physical Downlink Shared Channel (PDSCH) EPRE which OFDM symbol comprises no cell-specific RS to cell-specific RS and ρ_{B} is the ratio of PDSCH EPRE which OFDM symbol comprises cell-specific RS to cell-specific RS.

ρ_{A} can be expressed as

$${ρ}_{A} = \frac{{E}_{A}}{{E}_{RS}}$$

and ρ_{B} can be expressed as

$${ρ}_{B} = \frac{{E}_{B}}{{E}_{RS}} ,$$

where E_{A} is PDSCH EPRE for OFDM symbols comprising no cell-specific RS, E_{B} is PDSCH EPRE for OFDM symbols comprising cell-specific RS and E_{RS} is the energy of cell-specific RS.

Further, according to 3GPP TS 36.213, ρ_{A} is also equal to δ_{power offset}+ρ_{A}+1olog₁ₒ(2) when the user Equipment (UE) receives a PDSCH data transmission using pre-coding for transmit diversity with 4 cell-specific antenna ports; or equal to δ_{Power offset}+P_{A} otherwise; where δ_{power offset} is 0 for all PDSCH transmission schemes except multi-user MIMO and where P_{A} is a UE specific parameter provided by higher layers and specified in 3GPP TS 36.331 entitled: “Group Radio Access Network; Evolved Universal Terrestrial Radio Access (E-UTRA); Radio Resource Control (RRC); Protocol specification”.

In order to determine EPRE, it is common to configure P_{A} and P_{B provided by higher layers and select a ratio for}

$$\frac{{ρ}_{A}}{{ρ}_{B}} .$$

According to 3GPP TS 36.331, P_{B} is a common parameter, which is used to configure cells, whereas P_{A} is a UE specific parameter, which is used to configure UE parameters. P_{B} is an integer and selected from the domain [0, 3], while P_{A} is selected from a special domain comprising eight values.

The value of P_{A} influences the power of the REs, hence it is important to obtain the best value of P_{A} to guarantee the efficiency of power usage and power limit.

For a certain OFDM symbol, the power of the REs for a UE is determined as disclosed above. However, the frequency resource allocated to a UE comprises several subcarriers since an RB comprises 12 subcarriers. The same power is allocated to the different subcarriers. This has some drawbacks. In certain circumstances, the channel qualities may vary quickly, e.g. if the UE is moving about in the cell. In such circumstances, the power allocation may not be able to follow the rapid changes in channel qualities. This will cause a waste of power and low efficiency with regards to power usage. Furthermore, it will decrease system performance.

Still further, in the power allocation, no consideration is usually taken to fairness. Fairness is dealt with in radio resource scheduling. A scheduling function which does not consider fairness, typically only considers channel quality or condition when scheduling radio resources. Such a scheduling function will allocate radio resources primarily to UEs having favorable channel quality or condition and as a result will starve other UEs having unfavorable channel quality or condition. When scheduling radio resources, the scheduling function may make use of a fairness factor in order to schedule radio resources based both on channel quality and to avoid starving UEs having unfavorable channel quality or condition. One example of a scheduler employing fairness in scheduling radio resources to UEs in the cell is disclosed in the Francesco D Calabrese et al: “Performance of Proportional Fair Frequency and Time Domain Scheduling in LTE Uplink”, European Wireless 2009.

### SUMMARY

It is an object of the exemplifying embodiments to address at least some of the problems outlined above. In particular, it is an object of the exemplifying embodiments to provide a base station and a method therein for allocating power in downlink transmissions for a user equipment (UE) in a Long Term Evolution, (LTE) system, wherein consideration is taken to both channel quality and fairness in the power allocation.

According to an aspect a method for use in a base station for allocating power in downlink transmissions for a UE in an LTE system is provided. The method comprises receiving, from the UE, a report comprising a Reference Signal Received Quality, RSRQ, indicating a current channel quality of a downlink transmission with multiple subcarriers; retrieving, from a resource management scheduler of the base station, a fairness factor used for achieving a fairness in scheduling between UEs served by the base station. The method also comprises determining a combined factor based on the received RSRQ and the retrieved fairness factor, for resource blocks, RBs, related to the downlink transmissions, the RBs comprising subcarriers pertaining to resources to be allocated to the UE. Further, the method comprises determining a power for the resource blocks based on the determined combined factor; and allocating the determined power for the downlink transmission(s) for the UE.

According to another aspect, a base station in an LTE system adapted to allocate power in downlink transmissions for a UE is provided. The base station is adapted to receive, from the UE, a report comprising a Reference Signal Received Quality, RSRQ, indicating a current channel quality of a downlink transmission with multiple subcarriers. The base station is also adapted to retrieve, from a resource management scheduler of the base station, a fairness factor used for achieving fairness in scheduling between UEs served by the base station. Further, the base station is adapted to determine a combined factor based on the received RSRQ and the retrieved fairness factor for resource blocks, RBs, related to the downlink transmissions, said RBs comprising subcarriers pertaining to resources to be allocated to the UE. Still further, the base station is adapted to determine a power for the RBs based on the determined combined factor; and to allocate the determined power for the downlink transmission(s) towards the UE.

The base station and the method therein have several advantages. One advantage is that consideration is taken to power usage, channel quality and fairness when allocating power to downlink transmissions for the UE. This improves efficiency of power usage and it enhances the system throughput. A further advantage is that the method is dynamic, thereby enabling adaptive power allocation for downlink transmissions for UEs. Another advantage is that it is possible to control the influence of channel quality and the influence of fairness in the power allocation.

### BRIEF DESCRIPTION OF DRAWINGS

Embodiments will now be described in more detail in relation to the accompanying drawings, in which:

FIG. 1 is a schematic illustration of radio resources in an LTE system.

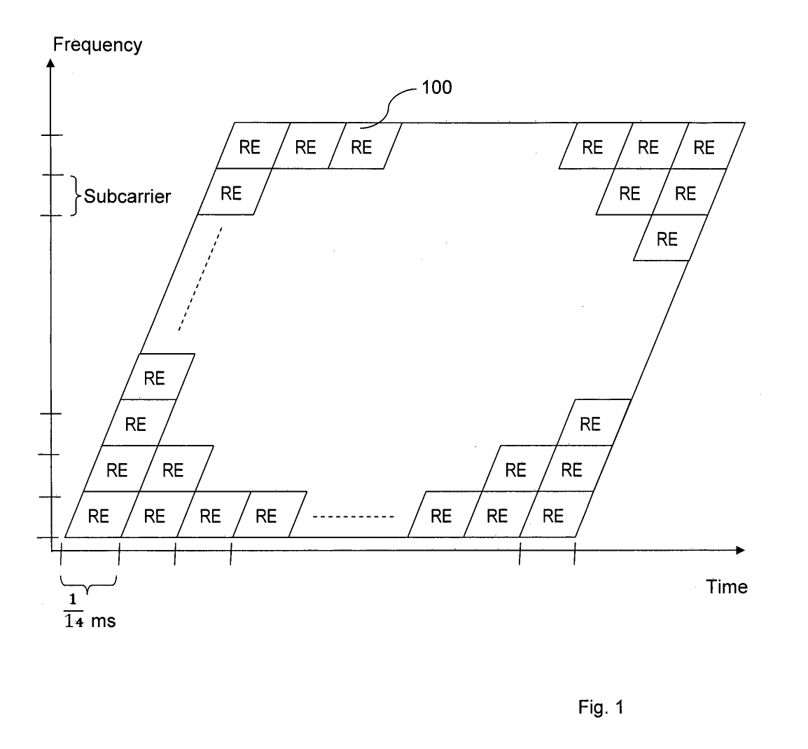

FIG. 2 is a flowchart of an exemplifying embodiment of a method in a base station for allocating power in downlink transmissions for a User Equipment.

FIG. 3 illustrates a water filling algorithm according to prior art.

FIG. 4 is a schematic block diagram of an exemplifying embodiment of a base station adapted to allocate power in downlink transmissions for a User Equipment.

### DETAILED DESCRIPTION

Briefly described, exemplifying embodiments of a base station and a method therein are provided for allocating power in downlink transmissions for a UE in an LTE system. The power allocation is performed in such a way that consideration is taken to both efficiency of power usage in the cell that the base station is serving and to a fairness factor used for scheduling radio resources to UEs in the cell being served by the base station.

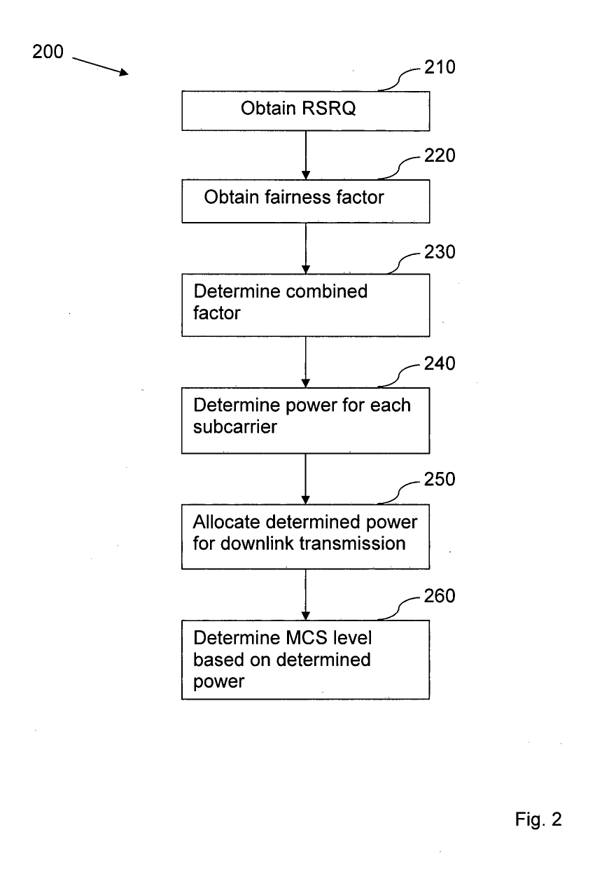

An exemplifying embodiment of such a method in a base station for allocating power in downlink transmissions for a UE in an LTE system with reference to the flowchart in FIG. 2. In this embodiment, the method comprises receiving 210 a report from the UE, the report comprising a Reference Signal Received Quality, RSRQ, indicating a current channel quality of a downlink transmission with multiple subcarriers. The method further comprises retrieving 220 a fairness factor from a resource management scheduler of the base station, the fairness factor being used for achieving fairness in scheduling between user equipments served by the base station. Still further, the method comprises determining 230 a combined factor based on the received RSRQ and the retrieved fairness factor, for resource blocks, RBs, related to the downlink transmissions, the RBs comprising subcarriers pertaining to resources to be allocated to the UE. The method also comprises determining 240 a power for the resource blocks based on the determined combined factor, and allocating 250 the determined power for the downlink transmission for the UE.

This has several advantages. One advantage is that consideration is taken to power usage, channel quality and fairness when allocating power to downlink transmissions for the UE. This improves efficiency of power usage and it enhances the system throughput. A further advantage is that the method is dynamic, thereby enabling adaptive power allocation.

In an example, the allocated power is communicated to the UE on a Physical Downlink Shared Channel, PDSCH.

According to an exemplifying embodiment, determining 240 a power for the RBs comprises, determining a power for subcarriers of the RBs for determining a Modulation and Coding Scheme, MCS level to be used by the UE.

In this embodiment, consideration is taken to individual subcarriers within an RB in order to improve efficiency of power usage and to enhance system throughput.

According to still an embodiment, determining 230 the combined factor comprises determining the combined factor by multiplying the received RSRQ and the retrieved fairness factor according to f=((RSRQ)^{a})*((fairness factor)^{b}), where f is the combined factor; a and b are modify factors with a value from 0 to 1.

As described above, the combined factor f is used for determining 240 a power for the resource blocks. By determining the combined factor according to f=((RSRQ)^{a})*((fairness factor)^{b}), it can be seen that the combined factor is dependent upon both the channel quality relating to power usage i.e. RSRQ and upon the fairness factor. Superscripts a and b are used to balance between optimisation of power usage and fairness. Since they both have an individual value from 0 to 1, it can be seen that the combined factor can be so to say biased towards optimisation of power usage or fairness.

According to yet an embodiment, allocating 250 the determined power for downlink transmission for the UE comprises using a predefined water filling function.

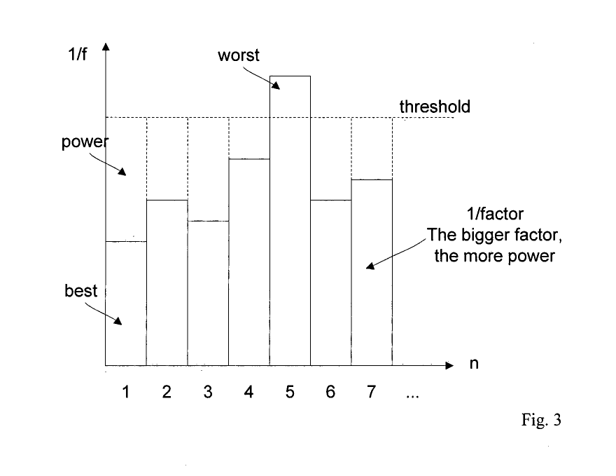

A water filling function is the most unfair function because the better the channel condition the more resources will be allocated to that channel. FIG. 3 illustrates a water filling algorithm according to prior art. The x-axis stands for channel number n and y-axis stands for channel quality 1/f. The bottom rectangle enclosed by real line for every channel number n indicates the channel quality. The top rectangle enclosed by broken line for every channel number indicates the power that could be allocated. The higher the channel condition(s) the less power is allocated, even no power if it is worst enough to exceed the threshold (as shown in FIG. 2 n=5); otherwise, it will allocated more power.

According to embodiments of the present invention, this unfairness of the water filing function is compensated for by the combined factor as described above.

Hence the combined factor is used as follows to reduce the unfairness of the water filling function. A target function is defined, the target function defining the maximum transmission rate, R. The defined target function is

$$\begin{matrix}max ( R ) = max ( {\sum }_{i} {log}_{2} ( 1 + {f}_{i} {P}_{i} ) ) \\ = max ( {log}_{2} {\prod }_{i} ( 1 + {f}_{i} {P}_{i} ) ) \\ = max ( {log}_{2} {\prod }_{i} ( 1 + {f}_{i} {a}_{i} P ) )\end{matrix} \qquad ( 1 )$$

where fᵢ is the combined factor for subcarrier or RB i, Pᵢ is the allocated power for subcarrier or RB i, P is the total power and aᵢ is the ratio between allocated power and total power for subcarrier or RB i. It shall be noted that aᵢ here is not the same as the superscript in the combined factor. In equation (1) the value of Pᵢ is unknown. However, Pᵢ corresponds to aᵢ*P. P is the total power and it is determined by the capability of the hardware, hence it is a design power value.

The water filling function as function of the combined factor is then given by:

$$F ( {a}_{i} , λ ) = {\sum }_{i} {log}_{2} ( 1 + {f}_{i} {a}_{i} P ) + λ ( {\sum }_{i} {a}_{i} - 1 ) \qquad ( 2 )$$

In order to solve the water filling function, the following is used:

$$\{ \begin{matrix}\frac{\partial F}{\partial {a}_{i}} = \frac{1}{ln 2} * \frac{1}{1 + {f}_{i} {a}_{i} P} * {f}_{i} P + λ = 0 \\ \frac{\partial F}{\partial {a}_{i}} = {\sum }_{i} {a}_{i} - 1 = 0\end{matrix} \qquad ( 3 )$$

This way aᵢ is determined by solving equations (3) and from the aᵢ, the value of Pᵢ which meets the target function (1) can be determined by Pᵢ=aᵢ*P.

According to still an embodiment, the method further comprises determining 260 a new MCS level based on the determined power for the subcarriers of the resource blocks.

Since the allocated power to the RBs or subcarriers may have changed since the reception 210 of the report from the UE, the report comprising the RSRQ, indicating a then current channel quality of a downlink transmission, the MCS level, according to an exemplary embodiment, may be determined with respect to the newly determined power for the subcarriers of the RBs to cope with recent channel quality.

In an example, the new determined MCS level is communicated to the UE on a Physical Downlink Control Channel, PDCCH.

It should be noted, that determination of MCS level may be performed in accordance with known MCS determination methods. Hence the embodiments herein are not restricted to any particular method of determining or calculating the MCS level.

An example of how to determine the MCS level is to determine a Signal to Noise Ratio, SINR, of the UE. The SINR will be influenced by e.g. transmission power, channel condition and so on. Also a Channel Quality Indicator, CQI, index is determined. This may be done e.g. by searching a SINR-BLER (Block Error Rate) table to determine a modulation order and maximum code rate. Further, an MCS index is determined. This can be performed e.g. by searching a modulation order—MCS index table usually predefined. The result may be more than one index. Further, a code rate for every MCS index is determined and then the code rate which is most proximal and less than a maximum code rate is determined, resulting in which MCS index is the most preferred.

Embodiments herein also disclose a base station in an LTE system adapted to allocate power in downlink transmissions for a UE. Some exemplifying embodiments will now be described with reference to FIG. 3. The exemplifying embodiments of the base station have the same objects and advantages as the method therein as described above. The exemplifying embodiments of the base station will therefore be briefly described in order to avoid unnecessary repetition.

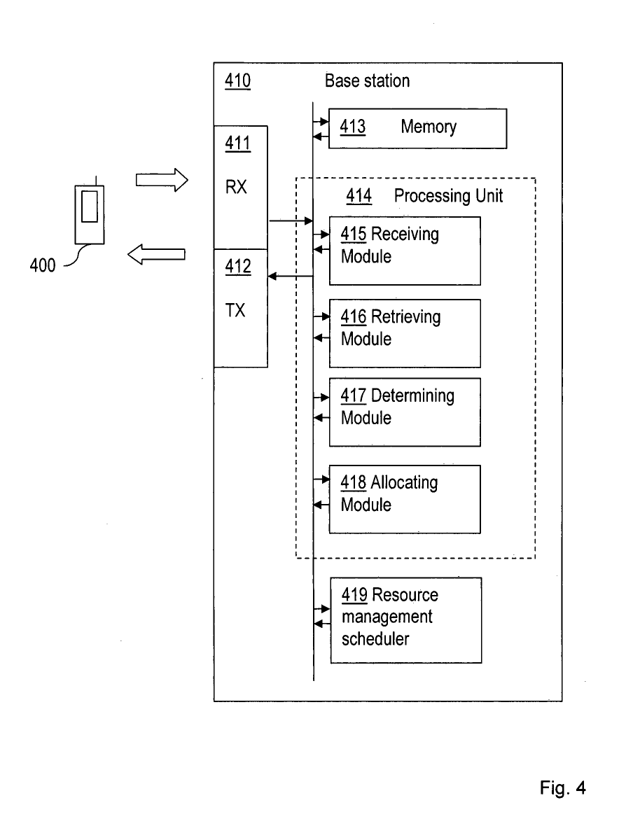

FIG. 4 is a schematic block diagram of an exemplifying embodiment of a base station in an LTE system adapted to allocate power in downlink transmissions for a UE.

A block diagram exemplifying a base station 410 is illustrated comprising a receiving, RX, 411 and transmitting, TX, 412 unit for supporting communication with the user equipment 400. RX and TX may be integrated into a same transceiver unit (not shown). The base station 410 further comprising a memory 413 and a processing unit 414.

The base station 410 is adapted to receive a report from the UE 400, the report comprising a Reference Signal Received Quality, RSRQ, indicating a current channel quality of a downlink transmission with multiple subcarriers. The base station is also adapted to retrieve a fairness factor from a resource management scheduler 419 of the base station, the fairness factor being used for achieving fairness in scheduling between user equipments served by the base station 410. Still further, the base station is adapted to determine a combined factor based on the received RSRQ and the retrieved fairness factor for resource blocks, RBs, related to the downlink transmissions. The RBs comprises subcarriers pertaining to resources to be allocated to the UE 400. The base station is also adapted to determine a power for the RBs based on the determined combined factor; and to allocate the determined power for the downlink transmission towards the UE 400.

According to an embodiment, the base station is further adapted to determine a power for subcarriers of the resource blocks for determining a MCS level to be used by the UE.

According to still an embodiment, the base station is further adapted to determine the combined factor by multiplying the received RSRQ and the retrieved fairness factor according to f=((RSRQ)^{a})*((fairness factor)^{b}), where f is the combined factor; a and b are modify factors with a value from 0 to 1.

Further, according to an embodiment, the base station is further adapted to allocate the determined power for downlink transmission for the UE using a predefined water filling function.

According to still an embodiment, the base station is further adapted to determine a new MCS level based on the determined power for the subcarriers of the resource blocks.

As shown in FIG. 4, the processing unit 414 comprises a receiving module 415 for receiving the report from the UE 400 indicating a current channel quality, via the RX unit 411. The processing unit 414 is also illustrated comprising a retrieving module 416 which is capable of retrieving the fairness factor from the resource management scheduler 419 illustrated as being comprised in the base station. The processing unit 414 is further illustrated having a determining module 417 and an allocating module 418. It should be noted that the modules are merely exemplifying illustrations and the processing unit 414 may comprise more modules or other modules. Likewise, the base station 410 may comprise more units or other units than is being illustrated in the exemplifying FIG. 4.

It should be noted that FIG. 4 merely illustrates various functional units and modules in the base station in a logical sense. The functions in practice may be implemented using any suitable software and hardware means/circuits etc. Thus, the embodiments are generally not limited to the shown structures of the base station and the functional units and modules. Hence, the previously described exemplary embodiments may be realised in many ways. For example, one embodiment includes a computer-readable medium having instructions stored thereon that are executable by the processing unit for performing the method. The instructions executable by the computing system and stored on the computer-readable medium perform the method steps of the present invention as set forth in the claims.

While the embodiments have been described in terms of several embodiments, it is contemplated that alternatives, modifications, permutations and equivalents thereof will become apparent upon reading of the specifications and study of the drawings. It is therefore intended that the following appended claims include such alternatives, modifications, permutations and equivalents as fall within the scope of the embodiments and defined by the pending claims.

1-10. (canceled)

11. A method for use in a base station for allocating power in downlink transmissions for a user equipment, UE, in a Long Term Evolution, LTE, system, the method comprising:
receiving, from the UE, a report comprising a Reference Signal Received Quality, RSRQ, indicating a current channel quality of a downlink transmission with multiple subcarriers,
retrieving, from a resource management scheduler of the base station, a fairness factor used for achieving a fairness in scheduling between user equipments served by the base station,
determining a combined factor, based on the received RSRQ and the retrieved fairness factor, for resource blocks, RBs, related to the downlink transmissions, said RBs comprising subcarriers pertaining to resources to be allocated to the UE,
determining a power for the resource blocks, based on the determined combined factor, and
allocating the determined power for the downlink transmissions for the UE.

12. The method according to claim 11, further comprising determining a power for subcarriers of the RBs, for determining a Modulation and Coding Scheme, MCS level to be used by the UE.

13. The method according to claim 11, wherein determining the combined factor comprises determining said combined factor by multiplying the received RSRQ and the retrieved fairness factor according to f=((RSRQ)a)*((fairness factor)b), where f is the combined factor; and a and b are modify factors with a value from 0 to 1.

14. The method according to claim 11, wherein allocating the determined power for downlink transmission for the UE comprises using a predefined water filling function.

15. The method according to claim 11, wherein the method further comprises determining a new MCS level based on the determined power for the subcarriers of the resource blocks.

16. A base station in a Long Term Evolution, LTE, system, adapted to allocate power in downlink transmissions for a user equipment, UE, based on being adapted to:
receive, from the UE, a report comprising a Reference Signal Received Quality, RSRQ, indicating a current channel quality of a downlink transmission with multiple subcarriers,
retrieve, from a resource management scheduler of the base station, a fairness factor used for achieving a fairness in scheduling between user equipments served by the base station,
determine a combined factor, based on the received RSRQ and the retrieved fairness factor, for resource blocks, RBs, related to the downlink transmissions, said RBs comprising subcarriers pertaining to resources to be allocated to the UE,
determine a power for the RBs based on the determined combined factor, and
allocate the determined power for the downlink transmissions towards the UE.

17. The base station according to claim 16, wherein the base station is further adapted to determine a power for subcarriers of the RBs, for determining a Modulation and Coding Scheme, MCS level to be used by the UE.

18. The base station according to claim 16, further adapted to determine the combined factor by multiplying the received RSRQ and the retrieved fairness factor according to f=((RSRQ)a)*((fairness factor)b), where f is the combined factor; and where a and b are modify factors with a value from 0 to 1.

19. The base station according to claim 16, further adapted to allocate the determined power for downlink transmission for the UE using a predefined water filling function.

20. The base station according to claim 16, further adapted to determine a new MCS level based on the determined power for the subcarriers of the resource blocks.
